(19) United States
(12) Patent Application Publication
(10) Pub. No.: US 2021/0120847 A1
(43) Pub. Date: Apr. 29, 2021

(54) METHOD OF PRODUCING A CANNED HYDROGEN INFUSED BEVERAGE

(71) Applicant: HyVida Brands, Inc., Northridge, CA (US)

(72) Inventor: Rick Smith, Muskegon, MI (US)

(21) Appl. No.: 17/141,764

(22) Filed: Jan. 5, 2021

Related U.S. Application Data
(63) Continuation of application No. 16/057,164, filed on Aug. 7, 2018.
(60) Provisional application No. 62/541,910, filed on Aug. 7, 2017.
(60) Provisional application No. 62/567,795, filed on Oct. 4, 2017.

(51) Int. Cl. A23L 2/54; C01B 3/04; B65D 1/16; B01F 3/04; B65D 17/28; C01B 3/08

(52) U.S. Cl. CPC A23L 2/54; C01B 3/042; B65D 1/165; B01F 3/04439; B01F 2003/04914; B01F 3/04794; C01B 3/08; B01F 2215/0022; A23V 2002/00; B65D 17/4012

(57) ABSTRACT

A method of producing a canned hydrogen infused beverage having the steps of: providing a can; introducing a solid that includes Magnesium metal into the can; filling the can with a carbonated liquid having water; generating molecular hydrogen from the reaction of the solid and the water; generating Magnesium Bicarbonate from the reaction of the solid and the carbonated liquid and sealing the can. A beverage in a can formed through disclosed processes is likewise disclosed.

### CROSS-REFERENCE TO RELATED APPLICATION

This application is a continuation of U.S. patent application Ser. No. 16/057,164 filed Aug. 7, 2018, entitled “Method of Producing a Canned Hydrogen Infused Beverage”, which claims priority from U.S. Pat. App. Ser. No. 62/541,910 entitled “Method of Producing a Canned Hydrogen Infused Carbonated Beverage” filed Aug. 7, 2017, and from U.S. Pat. App. Ser. No. 62/567,795 entitled “Method of Producing a Canned Hydrogen Infused Carbonated Beverage” filed Oct. 4, 2017, the entire disclosure of which is hereby incorporated by reference in its entirety.

### BACKGROUND OF THE DISCLOSURE

### 1. Field of the Disclosure

The disclosure relates in general to beverages, and more particularly, to a method of producing a canned hydrogen infused carbonated beverage, as well as a hydrogen infused non-carbonated beverage, as well as a can having any such a beverage therewithin. It will be understood that the term can is defined as including various different types of containers, made from any number of different materials, in different shapes, configurations, whether flexible or rigid, and, it is not limited to a can, beverage can or a metal can as is also explained hereinbelow. Further formulations and processes are disclosed for producing canned hydrogen infused carbonated and non-carbonated beverages.

### 2. Background Art

Recently, there has been an increasing demand for beverages that provide beneficial therapeutic effects. It has been found that providing molecular hydrogen to the body has beneficial therapeutic effects and functional benefits. To that end, a number of beverages have been developed that include molecular hydrogen infused therein. Typically, these beverages are based on water. Additionally, other solutions have been the providing of tablets or pill forms of metals, such as Magnesium, which, when introduced into water form molecular hydrogen therein. It is additionally desirable to provide more bioavailable forms of the different beneficial constituents, such as Magnesium in a Magnesium Bicarbonate form.

Generally, forming the same beverage in a carbonated form has been problematic, and typically has required expensive equipment for filling. This is true for carbonated and non-carbonated beverages alike.

Additionally, the production of such beverages, whether carbonated or non-carbonated has proven challenging on conventional, or lightly modified, filling equipment.

### SUMMARY OF THE DISCLOSURE

The disclosure is directed to a method of producing a canned hydrogen infused carbonated beverage comprising the steps of: providing a can; introducing a solid that includes metal into the can; filling the can with a carbonated liquid having water (with the understanding that the solid can be introduced after the step of filling); generating molecular hydrogen from the reaction of the solid and the water; and sealing the can.

In another aspect, the disclosure is directed to a beverage can. The beverage can has a body, a carbonated beverage and a solid. The body has an inner cavity. The carbonated beverage is within the can. The solid includes a metal introduced into the can which reacts with the water to form molecular hydrogen.

In some configurations, the metal is Magnesium.

In another aspect of the disclosure, the disclosure is directed to a method of producing a canned hydrogen infused beverage comprising the steps of: providing a can; providing a filler; preparing a mixture that includes Magnesium particles and water; filling the can with the mixture having Magnesium particles; sealing the can; and generating molecular hydrogen from the reaction of the Magnesium particles with the water, at least some of which molecular hydrogen is generated after sealing the can.

In some configurations, the method further comprises the step of carbonating the mixture prior to the step of filling the can with the mixture.

In greater detail, in an aspect of the disclosure, the disclosure is directed to a method of producing a canned hydrogen infused carbonated (and in some configurations, non-carbonated) beverage comprising the steps of: providing a can; introducing a solid that includes metal into the can; filling the can with a carbonated liquid having water; generating molecular hydrogen from the reaction of the solid and the water; and sealing the can. In some configurations, a non-carbonated liquid having water can be introduced.

In some configurations, the metal of the solid that is introduced into the can during the step of introducing comprises magnesium.

In some configurations, the solid comprises magnesium particles.

In some configurations, the magnesium particles include a coating.

In some configurations, the step of generating molecular hydrogen continues until any magnesium introduced into the can is in solution.

In some configurations, the carbonated liquid comprises any one or more of: carbonated water, beer, soft drinks, carbonated energy drinks, flavored carbonated water, spiked (alcohol) seltzers, and other, pre-mixed ready to drink alcoholic cocktails, as well as non-carbonated, juices, teas, coffees, and premixed ready to drink alcoholic cocktails.

In some configurations, the can comprises any one or more of: a metal container, a rigid plastic container, a flexible plastic container, a rigid glass container, a paperboard container, as well as combinations of the same.

In some configurations, the can comprises a metal can for beverages.

In some configurations, the method further comprises the step of: introducing at least one of a catalyst, a flavoring, a vitamin, caffeine, an electrolyte, sodium, a mineral, sugar and a preservative into the can.

In some configurations, the step of introducing occurs after the step of filling. In some such configurations, the step of generating occurs at least partially after the step of sealing.

In some configurations, the step of generating occurs at least partially after the step of sealing.

In some configurations, wherein the step of generating molecular hydrogen occurs both prior to and after the step of sealing.

In some configurations, the step of introducing occurs prior to the step of filling.

In another aspect of the disclosure, the disclosure is directed to a beverage container that includes a body, a carbonated beverage and a solid. The body has an inner cavity that is sealed. The carbonated beverage is positioned within the can. The solid includes a metal introduced into the can, prior to sealing, which reacts with the water to form molecular hydrogen.

In some configurations, the can comprises any one or more of: a metal container, a rigid plastic container, a flexible plastic container, a rigid glass container, a paperboard container, as well as combinations of the same.

In some configurations, the can comprises a metal can for beverages.

In some configurations, the solid comprises magnesium particles.

In some configurations, the magnesium particles include a coating.

In some configurations, any magnesium in the beverage is in solution.

In some configurations, the carbonated beverage comprises one of the group consisting of: carbonated water, beer, soft drinks, carbonated energy drinks, flavored carbonated water, spiked (alcohol) seltzers, and other, pre-mixed ready to drink alcoholic cocktails, as well as non-carbonated, juices, teas, coffees, and premixed ready to drink alcoholic cocktails.

In yet another aspect of the disclosure, the disclosure is directed to a method of producing a canned hydrogen infused beverage comprising the steps of: providing a can; providing a filler; preparing a mixture that includes magnesium particles and water; filling the can with the mixture having magnesium particles; sealing the can; and generating molecular hydrogen from the reaction of the magnesium particles with the water, at least some of which molecular hydrogen is generated after sealing the can.

In some configurations, the method further comprises the step of carbonating the mixture prior to the step of filling the can with the mixture.

In some configurations, the magnesium particles are coated.

In some configurations, the method includes the step of filling the can with nitrogen gas after the step of filling the can with the mixture having magnesium particles.

In some configurations, the method further includes the step of heating or pressurizing (that is, either one or both) the can after sealing the can to alter the rate at which the step of generating occurs.

In some configurations, the method further comprises the step of carbonating the mixture before the step of sealing the can.

In another aspect of the disclosure, the disclosure is directed to a method of producing a canned hydrogen infused carbonated beverage comprising the steps of: providing a can; introducing a solid that includes metal into the can, wherein the solid comprises Magnesium; filling the can with a carbonated liquid having water; generating molecular hydrogen from the reaction of the solid and the water; generating Magnesium Bicarbonate from the reaction of the solid and the carbonated liquid; and sealing the can (with the understanding that the can is often and typically sealed prior to the completion of the reaction forming hydrogen).

In some configurations, the method includes the step of introducing Magnesium Hydroxide into the can (or mixing bath) prior to sealing the can.

In some configurations, the carbonated liquid has 1.5 Volumes or more of carbon dioxide.

In some configurations, the combined carbon dioxide and hydrogen gas remains less than 6.5 Volumes after sealing the can.

In some configurations, the method further includes the step of introducing solids through infusion wherein the solids represent less than 3750 parts per million.

In some configurations, the Magnesium introduced into the can is less than 225 mg per liter of water.

In another aspect of the disclosure, the disclosure is directed to a beverage. The beverage comprises a sealed can having a volume. The volume has water, with the water being infused with carbon dioxide and infused with hydrogen gas, and, Magnesium Bicarbonate. The combination of carbon dioxide and hydrogen gas is less than 6.5 Volumes.

In some configurations, the combination of carbon dioxide is at least 1.5 Volumes.

In some configurations, the pH is less than 6.0.

In some configurations, the beverage further has dissolved solids, wherein a total amount of dissolved solids is less than 2750 mg/Liter.

In some configurations, the hydrogen concentration is greater than 1.6 parts per million.

### BRIEF DESCRIPTION OF THE DRAWINGS

The disclosure will now be described with reference to the drawings wherein:

FIG. 1a of the drawings is a flow chart of a process of producing a canned hydrogen infused carbonated beverage;

FIG. 1b of the drawings is another flow chart of a process of producing a canned hydrogen infused carbonated beverage;

FIG. 2a of the drawings is a schematic representation of a can undergoing the process of having a hydrogen infused carbonated beverage following the flow chart of FIG. 1a;

FIG. 2b of the drawings is a schematic representation of a can undergoing the process of having a hydrogen infused carbonated beverage following the flow chart of FIG. 2b; and

FIG. 3 of the drawings is a flow chart of another process of producing a hydrogen infused carbonated or non-carbonated beverage.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

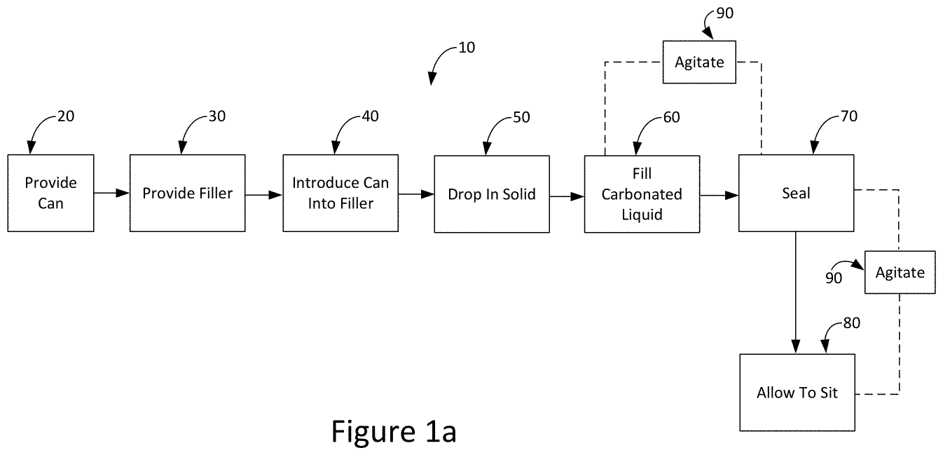

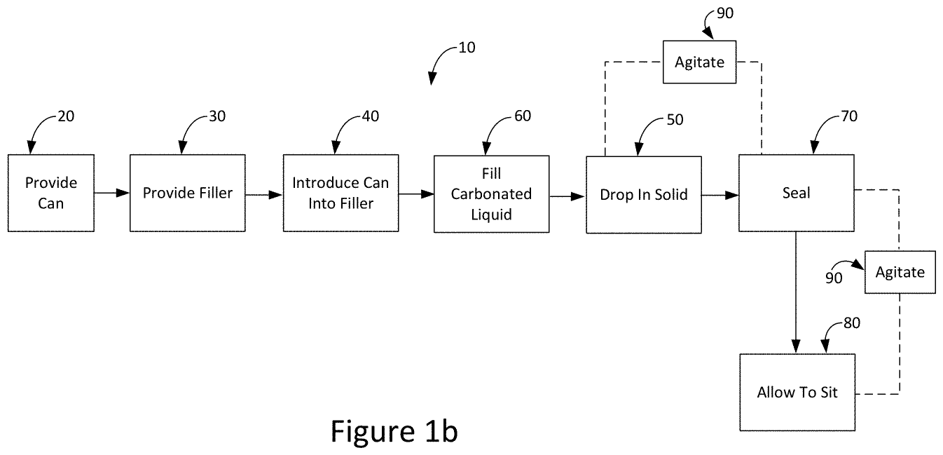

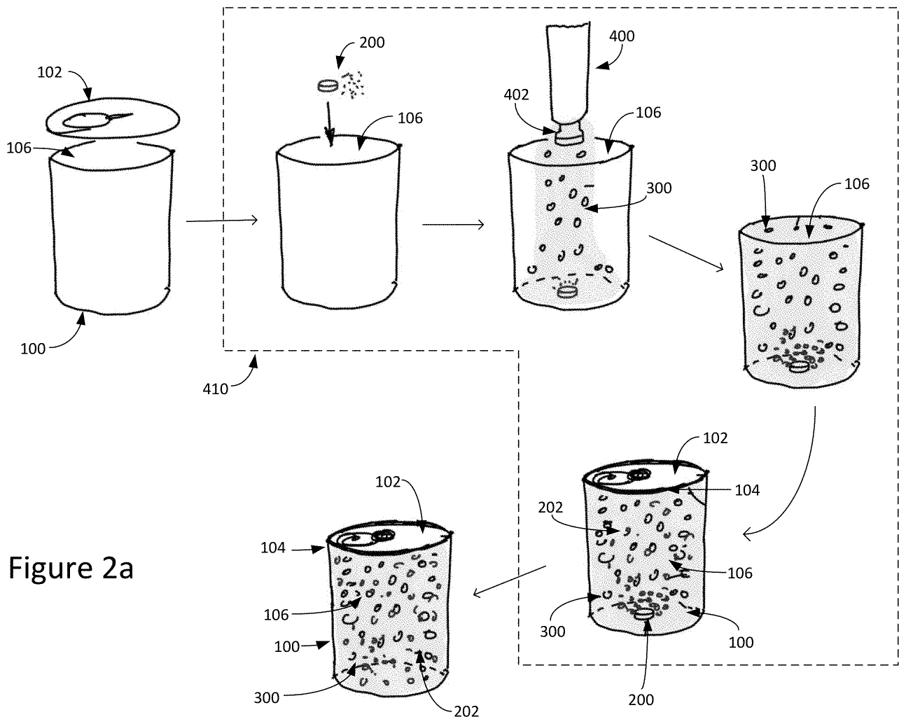

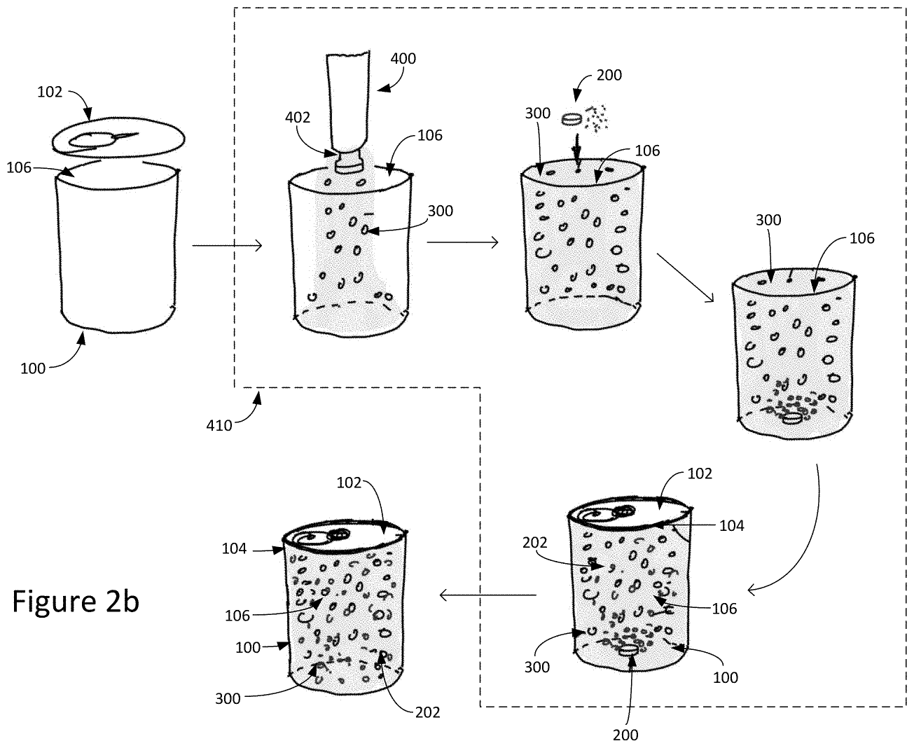

Referring now to the drawings and in particular to FIGS. 1a and/or 1b, the method of producing a canned hydrogen infused carbonated beverage is shown generally at 10. It will be understood that while the method shows the production of a single sealed can having a carbonated beverage infused with hydrogen, it is envisioned that a single piece of equipment (namely, a filler such as filler 410 (FIG. 2a and/or 2b)) can produce between dozens and tens of thousands of such cans per hour. Indeed, there is no limitation on the serialization of the production of such equipment.

The process starts with the providing of both the can at step 20 and the filling equipment at step 30. With reference to FIG. 2a or 2b, the can comprises a base container blank 100 and lid 102. The base container blank 100 defines inner cavity 106. The lid 102 includes a frangible portion that allows opening and ingress into the cavity 106 when the blank and the lid are joined together with what is known as a double seam can seal 104. Typically, such blanks and lids are formed from aluminum, however, other materials are used such as steel and tinplate. It will be understood that the disclosure is not directed to or limited to any particular type of can. Alternatively, bottles can be utilized as well (for example, plastic or glass), or pouches, however the disclosure will be described in a configuration utilizing cans. Additionally, the term can as read herein can refer to any of these different types of containers (i.e., a metal container, a rigid plastic container, like a bottle, a flexible plastic container such as a pouch, a rigid glass container, a paperboard container, as well as combinations of the same), and the disclosure is not limited to cans (and/or cans for beverage that are generally cylindrical and generally between 5 and 18 ounces).

The filling equipment is generally known in the art, and is available from any number of different filling equipment manufacturers. Such filling equipment can be fully automated or may be manual. In some configurations, the user fills and seals cans one at a time. In other configurations, fully automated equipment can fill and seal upwards of 4000 to 25000 cans per hour. Such equipment is known to those of skill in the art.

With both the can and the filler provided, the can is next introduced into the filler at step 40. Generally, the can is fully cleaned and sterilized prior to or at the beginning of the process in the filling equipment. A number of different methods and systems are known for providing a clean and sterilized base container blank to a filler.

With reference to FIGS. 1a and 2a, once the can is introduced into the filler, a solid (i.e., particles, or the like) or tablet form of Magnesium is introduced into the can (while it will be understood that another metal that degrades into molecular hydrogen is likewise contemplated, including, but not limited to Zinc, among others). It will be understood that this step can occur prior to the introduction into the filler by a completely separate step. It will also be understood that this step can occur after the step 60 of filling the can with carbonated liquid (as in the configuration of FIGS. 1b and 2b). It will be understood that for the reaction to occur, the proper conditions (i.e., pH and the like) are present.

In the configuration shown in FIGS. 1a and 2a, the solid comprises a tablet that includes magnesium in a form that when combined with water will yield, among other things molecular hydrogen (H₂), such as, for example, magnesium metal in small particles, such as, for example, granular magnesium. One such tablet is disclosed in U.S. Pat. App. Pub. No. 2016/0113865, which application is hereby incorporated by reference in its entirety. Another such product is a tablet that is sold under the name rejuvenation by HRW Natural Health Products Inc. of New Westminster, BC, Canada. In addition to Magnesium other materials may be added such as catalysts, flavorings, vitamins, caffeine, electrolytes, (sodium, minerals and/or sugar), preservatives and the like. It will also be understood that at this step, other solids may be added, such as flavorings, sweeteners or the like. It will also be understood that the liquid may be infused with Nitrogen gas (N₂) as well as being carbonated (i.e., inclusive of CO₂). The figure also discloses a magnesium powder, such as granulated magnesium.

Next, at step 60, the base container blank 100 is filled with a carbonated liquid, such as carbonated water 300. In the configuration shown in FIG. 2a, the filling is accomplished through fill valve 402, wherein the carbonated liquid is directed through the outlet 402. In other configurations, the product can be other than carbonated water, such as, for example, a carbonated beverage (i.e., cola, beer, among others), beer, soft drinks, carbonated energy drinks, flavored carbonated water, as well as, spiked (alcohol) seltzers, and other, pre-mixed ready to drink alcoholic cocktails, as well as non-carbonated, juices, teas, coffees, and premixed ready to drink alcoholic cocktails.

As the container is filled and thereafter, the magnesium in the presence of water undergoes a reaction producing, among other things, molecular hydrogen, Hz. This process continues as the can proceeds to the step of sealing the inner cavity 106 through coupling of the lid 102 in a double seam can seal 104. Eventually, and preferably (although not required), any magnesium is in solution in the carbonated water, and no solids remain in the inner cavity 106. In other configurations, some solids (which may be in the form of Magnesium Oxide) remain. It has been found that the resulting can, in many instances, does not exhibit over pressurization through the addition of the magnesium 200. In some configurations, it is advantageous to allow the can to sit or to agitate the can to achieve the dissolution of the Magnesium and the formation of the molecular hydrogen.

Some cans were prepared in accordance with the above-described method. After allowing the cans to sit (and in some cases, be cooled through refrigeration), testing was completed to determine the amount of molecular hydrogen that is in the can. When tested with carbonated water, readings of 2.1 ppm were observed. It is known that positive and beneficial results are achieved with 1.5 ppm or more of molecular hydrogen. Thus, even with the carbonation, which competes with the hydrogen in solution, the ending result is that therapeutic levels of molecular hydrogen were observed through the method as disclosed.

In another aspect of the disclosure, it is contemplated that the process can be modified to preclude step 50 and to make the process suitable for use on conventional filling equipment without modification (preferably, while modification is not precluded or limited). It is likewise contemplated that the process can be applied to non-carbonated liquids as well, while the disclosure above discusses carbonated liquids, with appropriate conditions for the reaction to occur.

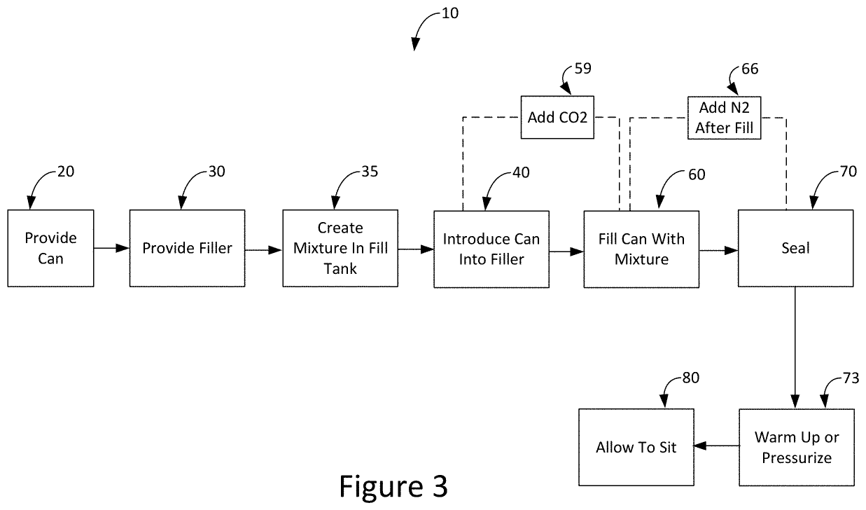

In particular, such a process is disclosed in FIG. 3. In such a process, as with the first process, the steps 20 and 30 are the same. In the process disclosed in FIG. 3, it is contemplated that a mixture is prepared in the tank at step 33. The mixture in the tank, as with the previous mixture, may include any number of different ingredients, flavorings, and the like. Additionally, the base material may comprise water, a juice, coffee, tea or other drinks, including alcoholic drinks like wine, and carbonated drinks including carbonated wine known to those of skill in the art, without limitation.

However, in the configuration contemplated, magnesium particles are added. The particles may have a number of different shapes and sizes. It will be understood that the shapes and sizes are preferably optimized for a slow reaction in cold water with a faster reaction in warm water. That is, the reaction of the Magnesium in the water increases with temperature. It is preferred that the mixture is maintained at a relatively low temperature (i.e., <5° C., for example), to limit the reaction between the Magnesium and the water while in the relatively larger mixing tank (or the bowl of the filler, for example). It is likewise contemplated that the Magnesium particle size has a specific gravity close to 1.0 so as to help make a homogenous mixture. Of course, other particle sizes are likewise contemplated as are other specific gravities, such as a specific gravity of 1.7, for example, and without being limiting.

In certain configurations, for any of the above different processes, it may be desirable to coat the Magnesium particles to retard the reaction time. One encapsulation technology can encapsulate the Magnesium in a dextrose coating (while other coatings are contemplated), and such coating is available from Spray-Tek of Middlesex N.J. Other coating technologies are likewise contemplated, such as the formation of an oxidation layer in a controlled fashion over the Magnesium to limit degradation or to retard degradation upon exposure to water. It is further contemplated that acids or other accelerators or catalysts can be added to the mixture to either increase or decrease the reaction time of the Magnesium and the water. It has been observed that Carbonic Acid found within Carbonated Water, seems to act as a catalyst.

The steps 40 and 60 remain as described above, with the addition of carbonation in step 59 in certain beverage configurations. It will be understood that in certain configurations, it may be desirable to produce a non-carbonated beverage while in other configurations, it may be desirable to produce a carbonated beverage. It will be understood that typically, the carbonation is added just prior to filling by mixing the same with the mixture, again just prior to filling. While other variations are contemplated, it is desirable to have the present process be acceptable for use with convention filling equipment, minimizing variation and modification. It will further be understood that generally, the introduction of carbonation (as a result of the carbonic acid created during the carbonation lowers the pH of the water) increases the reaction rate of Magnesium and water, increasing the generation of Hydrogen gas.

In certain configurations, it is desirable to add a dosing of Nitrogen gas to the unoccupied space within the container (that is, to displace any oxygen that may remain in the can when sealed). In some configurations, such a nitrogen dosing, represented by the step 66, may be omitted.

At step 70, the can is sealed, as in the prior process. Once sealed, at step 73, the temperature of the can, and its contents, is raised. In some configurations, the temperature may only be raised to room temperature for example (i.e., 20° C., for example). In other configurations, the temperature may be raised to a higher or lower temperature, such as, for example, temperatures between 6° C. and 45° C. Of course, such ranges are exemplary, and not to be deemed limiting.

In still other configurations, at step 73, the can may be introduced into a pasteurization process wherein the temperature is raised to in excess of 60° C. for a predetermined period of time. In either case, the increase in temperature increases the rate of reaction between the Magnesium and water (as well as generally, any coating placed over the Magnesium), thereby increasing the rate at which Hydrogen gas is produced. It is understood that pasteurization processes can occur at various temperatures between approximately 63° C. and 138° C., and at different temperatures, different levels of exposure are necessary to achieve pasteurization.

Advantageously, with the addition of Magnesium (to form Hydrogen gas), it is generally necessary to reduce the level of carbonation. The Magnesium particles can be designed or tuned in such a manner that the generation of Hydrogen gas occurs after the pasteurization process. As a result, cans can be subjected to the pasteurization process (through a number of processes, including but not limited to tunnel pasteurizing) at a lower pressure within the can (due to the Magnesium particles to water reaction not being completed), wherein the pressure increases after the pasteurizing process through the Magnesium and water reaction. Thus, the pressure at the time of consumption may be greater than would have been possible prior to pasteurization due to pressure limits in the pasteurization process. For example, the Magnesium particles can be formed such that the reaction occurs over a period of time at the various given temperatures. In one configuration, the process may require 24 hours at ambient temperature. In another configuration, the process may require 18 hours at ambient temperature after pasteurization. The different configurations are not to be deemed limiting, but to be exemplary of the different methods and processes that can be tailored for different beverages and different environments of use and consumption.

It will further be understood that, in certain configurations, it will be desirable to form a beverage that has infused hydrogen and forms of Magnesium that are as bioavailable to a user. For example, Magnesium Bicarbonate is a water soluble Magnesium salt that is 12× more bioavailable than Magnesium Oxide pills. Therefore, it is contemplated that by selecting the proper ranges of the different constituents, it is possible to have the deposited Magnesium particles depleted (or converted) from Mg to Mg(OH)2 and then to MG(HCO3)2, while maintaining a proper amount of Hydrogen infusion, a proper pressure and a desired pH.

It has been determined that to achieve desirable results, the following limiting criteria is preferred. Specifically, the constituents are less than 225 mg/L of elemental Magnesium (for example, in the form of shavings, small particles, and/or pellets), the carbon dioxide volumes are less than or equal to 1.5 volumes, the combined carbon dioxide and hydrogen volumes are less than 6.5, the pH is less than 6.0 and the total dissolved solids (TDS) are less than or equal to 2,750 mg/L. It will be understood that the term “volumes” is a beverage industry term analogous to Atmospheres of pressure.

It will be understood that the introduction of additional acids, such as juices (for example, citric acid) will tend to lower the pH and maintain the Mg reaction with the water at higher pressures (or volumes).

A sample beverage was prepared. The beverage that was canned, included a liter of purified water having a TDS of approximately 100 ppm are infused. Additionally, the water is carbonated to 3.4 Volumes of carbon dioxide. Finally, 90 mg of Magnesium is added to the beverage. Once the beverage is prepared it is placed into a container (or, of course, in several containers separate containers). The container is then sealed. After passage of time, the constituents react within the sealed container (wherein the time is dependent on ambient conditions for the container). After the passage of time, an equilibrium is reached within the container. The resulting Magnesium has been depleted or converted primarily into Magnesium Bicarbonate through a series of reactions. The final container has approximately 4.5 Volumes of gas infused within the liquid, which comprises approximately 3.4 Volumes of carbon dioxide and approximately 1.1. volumes of hydrogen gas (approximately 1.8 ppm of hydrogen gas). The beverage has a TDS of approximately 200 and a pH of approximately 4.5.

Advantageously, the resulting beverage has an operating range (i.e., pressure) that is within the standard beverage packaging, a good taste, a proper pH, a good bubbly feel (combination of the carbon dioxide and the hydrogen gasses), with therapeutic levels of hydrogen gas as can be seen at http://www.molecularhydrogeninstitute.com/, and for example, includes 1.6 ppm of Hydrogen concentration or greater. Additionally, the beverage has a highly bioavailable form of Magnesium that can readily be absorbed by the body of a user.

It is additionally contemplated that prior to sealing the container, additional Magnesium Bicarbonate can be added to the beverage. Such an addition does not undesirably affect the other reactions but provides additional highly bioavailable forms of Magnesium. Such a level of Magnesium Bicarbonate is difficult to achieve while maintaining the beverage within the desirable beverage parameters outlined above. In some configurations, this can be achieved by adding Magnesium Hydroxide prior to sealing the container or in the mixing bath in the feed water. This will result in additional Magnesium Bicarbonate through reactions, while generally not impacting the reaction to form hydrogen gas.

It is contemplated that, in addition to the constituents in the examples and those set forth above, additional features or beverage additives can be included, such as, for example, caffeine, colorants, flavor aides and the like. It is also contemplated that juices may be combined.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A method of producing a canned hydrogen infused carbonated beverage comprising the steps of:
providing a can;
introducing a solid that includes metal into the can, wherein the solid comprises Magnesium;
filling the can with a carbonated liquid having water;
generating molecular hydrogen from the reaction of the solid and the water;
generating Magnesium Bicarbonate from the reaction of the solid and the carbonated liquid; and
sealing the can.

2. The method of claim 1 further comprising the step of introducing Magnesium Bicarbonate into the can prior to sealing the can.

3. The method of claim 1 wherein the carbonated liquid has 1.5 Volumes or more of carbon dioxide.

4. The method of claim 3 wherein the combined carbon dioxide and hydrogen gas remains less than 6.5 Volumes after sealing the can.

5. The method of claim 1 further includes the step of introducing solids through infusion wherein the solids represent less than 3750 parts per million.

6. The method of claim 1 wherein the Magnesium introduced into the can is less than 225 mg per liter of water.

7. A beverage comprising:
a sealed can having a volume, the volume having:
water;
the water being infused with carbon dioxide;
the water being infused with hydrogen gas;
Magnesium Hydroxide;
wherein, the combination of carbon dioxide and hydrogen gas is less than 6.5 Volumes.

8. The beverage of claim 7 wherein the combination of carbon dioxide is at least 1.5 Volumes.

9. The beverage of claim 7 wherein the pH is less than 6.0.

10. The beverage of claim 7 further comprising dissolved solids, wherein a total amount of dissolved solids is less than 2750 mg/Liter.

11. The beverage of claim 7 wherein the hydrogen concentration is greater than 1.6 parts per million.
